(19) United States
(12) Patent Application Publication
(10) Pub. No.: US 2011/0193842 A1
(43) Pub. Date: Aug. 11, 2011

(54) LIQUID CRYSTAL DISPLAY AND METHODS OF DRIVING SAME

(75) Inventors: Yu-Cheng Tsai, Hsinchu (TW); Kuo-Hsien Lee, Hsinchu (TW); Chao-Liang Lu, Hsinchu (TW); Jing-Tin Kuo, Hsinchu (TW)

(73) Assignee: AU OPTRONICS CORPORATION, Hsinchu (TW)

(21) Appl. No.: 12/703,896

(22) Filed: Feb. 11, 2010

(51) Int. Cl. G09G 3/36; G09G 5/00; G02F 1/1343

(52) U.S. Cl. 345/209; 345/92; 349/37; 349/38; 349/139

(57) ABSTRACT

A liquid crystal display (LCD) and methods of driving same. In one embodiment, the LCD) includes a plurality of gate lines, {Gₙ}, spatially arranged along a row direction; a plurality of data lines, {Dₘ}, spatially arranged along a column direction perpendicular to the row direction, and a plurality of pixels, {P_{n,m}}, spatially arranged in the form of a matrix, where m=1, 2, . . . , M, n=1, 2, . . . , N, and M and N are positive integers. Each pixel P_{n,m} is defined between two neighboring gate lines Gₙ and Gₙ₊₁ and two neighboring data lines Dₘ and Dₘ₊₁, and comprises a first sub-pixel electrode, a second sub-pixel electrode, a first transistor having a gate electrically coupled to the gate line Gₙ₊₁, a source and a drain electrically coupled to the first sub-pixel electrode, a second transistor having a gate electrically coupled to the gate line Gₙ, a source electrically coupled to the source of the first transistor and a drain electrically coupled to the second sub-pixel electrode, and a third transistor having a gate electrically coupled to the gate line Gₙ₊₂, a source electrically coupled to one of the two neighboring data lines Dₘ and Dₘ₊₁ and a drain electrically coupled to the sources of the first and second transistors.

### FIELD OF THE INVENTION

The present invention relates generally to a liquid crystal display (LCD), and more particularly, to an LCD that utilizes an HSD3 driving scheme to reduce power consumption and improve performance and methods of driving same.

### BACKGROUND OF THE INVENTION

A liquid crystal display (LCD) device includes an LCD panel formed with liquid crystal cells and pixel elements with each associating with a corresponding liquid crystal cell and having a liquid crystal (LC) capacitor and a storage capacitor, a thin film transistor (TFT) electrically coupled with the liquid crystal capacitor and the storage capacitor. These pixel elements are substantially arranged in the form of a matrix having a number of pixel rows and a number of pixel columns. Typically, gate signals are sequentially applied to the number of pixel rows for sequentially turning on the pixel elements row-by-row. When a gate signal is applied to a pixel row to turn on corresponding TFTs of the pixel elements of a pixel row, source signals (i.e., image signals) for the pixel row are simultaneously applied to the number of pixel columns so as to charge the corresponding liquid crystal capacitor and storage capacitor of the pixel row for aligning orientations of the corresponding liquid crystal cells associated with the pixel row to control light transmittance therethrough. By repeating the procedure for all pixel rows, all pixel elements are supplied with corresponding source signals of the image signal, thereby displaying the image signal thereon.

It is known if a substantially high voltage potential is applied in the liquid crystal layer for a long period of time, the optical transmission characteristics of the liquid crystal molecules may change. This change may be permanent, causing an irreversible degradation in the display quality of the LCD. In order to prevent the LC molecules from being deteriorated, an LCD device is usually driven by using techniques that alternate the polarity of the voltages applied across a LC cell. These techniques may include inversion schemes such as frame inversion, row inversion, column inversion, and dot inversion. Typically, notwithstanding the inversion schemes, a higher image quality requires higher power consumption because of frequent polarity conversions. Such LCD devices, in particular thin film transistor (TFT) LCD devices, may consume significant amounts of power.

Approaches for reducing the power consumption of an LCD exist, such as a half source driving configuration of pixels, as shown in FIG. 6, which is referred to HSD2 in the disclosure. FIG. 6(a) shows waveforms of gate signals g₁ and g₂ sequentially applied to gate lines G1 and G2 of the LCD, respectively. FIGS. 6(b)-(f) show corresponding charging and holding processes of two sub-pixels P1 and P2 defined by two gate lines G1 and G2 and two data lines D1 and D2. For such an approach, during the timing sequences (states), t0, t1, . . . , and t4, the sub-pixel P2 has twice feed-throughs but the sub-pixel P1 has only one feed-through. Accordingly, the potential voltages charged in the sub-pixels P1 and P2 are different. The non-uniformity of the potential voltages in the sub-pixels P1 and P2 cause the mura effect, a defect in intensity in displayed images.

Therefore, a heretofore unaddressed need exists in the art to address the aforementioned deficiencies and inadequacies.

### SUMMARY OF THE INVENTION

The present invention, in one aspect, relates to an LCD. In one embodiment, the LCD includes a plurality of gate lines, {Gₙ}, n=1, 2, . . . , N, N being an integer greater than zero, spatially arranged along a row direction, a plurality of data lines, {Dₘ}, m=1, 2, . . . , M, M being an integer greater than zero, spatially arranged crossing the plurality of gate lines {Gₙ} along a column direction perpendicular to the row direction, and a plurality of pixels, {P_{n,m}}, spatially arranged in the form of a matrix.

Each pixel P_{n,m} is defined between two neighboring gate lines Gₙ and Gₙ₊₁ and two neighboring data lines Dₘ and Dₘ₊₁, and comprises a first sub-pixel electrode, a second sub-pixel electrode, a first transistor having a gate electrically coupled to the gate line Gₙ₊₁, a source and a drain electrically coupled to the first sub-pixel electrode, a second transistor having a gate electrically coupled to the gate line Gₙ, a source electrically coupled to the source of the first transistor and a drain electrically coupled to the second sub-pixel electrode, and a third transistor having a gate electrically coupled to the gate line Gₙ₊₂, a source electrically coupled to one of the two neighboring data lines Dₘ and Dₘ₊₁ and a drain electrically coupled to the sources of the first and second transistors. In one embodiment, the source of the third transistor of the pixel P_{n,m} is electrically coupled to the data line Dₘ. In another embodiment, the source of the third transistor of the pixel P_{n,m} is electrically coupled to the data line Dₘ when n is an odd positive integer, or electrically coupled to the data line Dₘ₊₁ when n is an even positive integer.

Additionally, the LCD also includes a gate driver for generating a plurality of gate signals respectively applied to the plurality of gate lines {Gₙ}, wherein the plurality of gate signals is configured to turn on the transistors connected to the plurality of gate lines {Gₙ} in a predefined sequence, and a data driver for generating a plurality of data signals respectively applied to the plurality of data lines {Dₘ}, wherein the plurality of data signals is configured such that any two neighboring data signals have inverted polarities. Each of the plurality of gate signals is configured to have a waveform. The waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, where the (j+1)-th duration Γⱼ₊₁ is immediately after the j-th duration Γⱼ, j=1, 2, 3 and 4, V₁=V₃=V₅>V₂=V₄, Γ₂=Γ₁/2, Γ₃=(Γ₁−t)/2, Γ₄=t, Γ₅=Γ₃, and Γ₁>>t. In one embodiment, the waveform of each of the gate signals is sequentially shifted from one another by the duration of Γ₁.

In one embodiment, the LCD further includes at least one common electrode formed in relation to the first and second sub-pixel electrodes of each pixel P_{n,m}.

In one embodiment, each pixel P_{n,m} further comprises a liquid crystal (LC) capacitor, a second LC capacitor, a first storage capacitor and a second storage capacitor. The first LC capacitor and the first storage capacitor are electrically coupled between the first sub-pixel electrode and the at least one common electrode in parallel. The second LC capacitor and the second storage capacitor are electrically coupled between the second sub-pixel electrode and the at least one common electrode in parallel.

In one embodiment, the first sub-pixel electrode, the first transistor, the first LC capacitor, and the first storage capacitor of each pixel P_{n,m} define a first sub-pixel, P_{n,m}(1), of the pixel P_{n,m}. The second sub-pixel electrode, the second transistor, the second LC capacitor, and the second storage capacitor of each pixel P_{n,m} define a second sub-pixel, P_{n,m}(2), of the pixel P_{n,m}.

In another aspect, the present invention relates to a method of driving an LCD. In one embodiment, the method includes the step of providing an LCD comprising a plurality of gate lines, {Gₙ}, n=1, 2, . . . , N, N being an integer greater than zero, spatially arranged along a row direction, a plurality of data lines, {Dₘ}, m=1, 2, . . . , M, M being an integer greater than zero, spatially arranged crossing the plurality of gate lines {Gₙ} along a column direction perpendicular to the row direction, and a plurality of pixels, {P_{n,m}}, spatially arranged in the form of a matrix.

Each pixel P_{n,m} is defined between two neighboring gate lines Gₙ and Gₙ₊₁ and two neighboring data lines Dₘ and Dₘ₊₁, and comprises a first sub-pixel electrode, a second sub-pixel electrode, a first transistor having a gate electrically coupled to the gate line Gₙ₊₁, a source and a drain electrically coupled to the first sub-pixel electrode, a second transistor having a gate electrically coupled to the gate line Gₙ, a source electrically coupled to the source of the first transistor and a drain electrically coupled to the second sub-pixel electrode, and a third transistor having a gate electrically coupled to the gate line Gₙ₊₂, a source electrically coupled to one of the two neighboring data lines Dₘ and Dₘ₊₁ and a drain electrically coupled to the sources of the first and second transistors. In one embodiment, the source of the third transistor of the pixel P_{n,m} is electrically coupled to the data line Dₘ. In another embodiment, the source of the third transistor of the pixel P_{n,m} is electrically coupled to the data line Dₘ when n is an odd positive integer, or electrically coupled to the data line Dₘ₊₁ when n is an even positive integer.

The method also includes the step of applying a plurality of gate signals to the plurality of gate lines {Gₙ} and a plurality of data signals to the plurality of data lines {Dₘ}, respectively, wherein the plurality of gate signals is configured to turn on the transistors connected to the plurality of gate lines {Gₙ} in a predefined sequence, and the plurality of data signals is configured such that any two neighboring data signals have inverted polarities.

In one embodiment, each of the plurality of gate signals is configured to have a waveform. The waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, where the (j+1)-th duration Γⱼ₊₁ is immediately after the j-th duration Γⱼ, j=1, 2, 3 and 4, V₁=V₃=V₅>V₂=V₄, Γ₂=Γ₁/2, Γ₃=(Γ₁−t)/2, Γ₄=t, Γ₅=Γ₃, and Γ₁>>t. In one embodiment, the waveform of each of the gate signals is sequentially shifted from one another by the duration of Γ₁.

In yet another aspect, the present invention relates to an LCD. In one embodiment, the LCD panel comprises a plurality of pixels, {P_{n,m}}, spatially arranged in the form of a matrix, n=1, 2, . . . , N, and m=1, 2, . . . , M, and N, M being an integer greater than zero. Each pixel P_{n,m} includes a first sub-pixel electrode, a second sub-pixel electrode, a first switching element electrically coupled to the first sub-pixel electrode, a second switching element electrically coupled to the second sub-pixel electrode, and a third switching element electrically coupled to the first and second switching elements.

The LCD further comprises a plurality of gate lines, {Gₙ}, spatially arranged along a row direction. Each pair of two neighboring gate lines Gₙ and Gₙ₊₁ defines a pixel row P_{n,{m}} of the pixel matrix {P_{n,m}} therebetween and is electrically coupled to the first and second switching elements of each pixel in the pixel row P_{n,{m}}, respectively.

The LCD also comprises a plurality of data lines, {Dₘ}, spatially arranged crossing the plurality of gate lines {Gₙ} along a column direction perpendicular to the row direction. Each pair of two neighboring data lines Dₘ and Dₘ₊₁ defines a pixel column, P_{{n},m}, of the pixel matrix {P_{n,m}} therebetween, and is electrically coupled to the third switching element of each pixel P_{n,m} in the pixel column, P_{{n},m}.

Moreover, the LCD includes a gate driver for generating a plurality of gate signals respectively applied to the plurality of gate lines {Gₙ}, wherein the plurality of gate signals is configured to turn on the switching elements connected to the plurality of gate lines {Gₙ} in a predefined sequence, and a data driver for generating a plurality of data signals respectively applied to the plurality of data lines {Dₘ}, wherein the plurality of data signals is configured such that any two neighboring data signals have inverted polarities.

In one embodiment, the first sub-pixel electrode and the first switching element of each pixel P_{n,m} define a first sub-pixel, P_{n,m}(1), of the pixel P_{n,m}. The second sub-pixel electrode and the second switching element of each pixel P_{n,m} define a second sub-pixel, P_{n,m}(2), of the pixel P_{n,m}.

In one embodiment, each of the first, second and third switching elements of the pixel P_{n,m} of the pixel matrix {P_{n,m}} is a field-effect thin film transistor having a gate, a source and a drain. The gate, the source and the drain of the first switching element of the pixel P_{n,m} are electrically coupled to the gate line Gₙ₊₁, the source of the second switching element of the pixel P_{n,m}, and the first sub-pixel electrode of the pixel P_{n,m}, respectively. The gate, the source and the drain of the second switching element of the pixel P_{n,m} are electrically coupled to the gate line Gₙ, the source of the first switching element of the pixel P_{n,m}, and the second sub-pixel electrode of the pixel P_{n,m}, respectively. In one embodiment, the gate, the source and the drain of the third switching element of the pixel P_{n,m} are electrically coupled to the gate line Gₙ₊₂, the data line Dₘ, and the sources of the first and second switching elements of the pixel P_{n,m}, respectively. In another embodiment, the gate and the drain of the third switching element of the pixel P_{n,m} are electrically coupled to the gate line Gₙ₊₂ and the sources of the first and second switching elements of the pixel P_{n,m}, respectively, while the source of the third transistor of the pixel P_{n,m} is electrically coupled to the data line Dₘ when n is an odd positive integer, or electrically coupled to the data line Dₘ₊₁ when n is an even positive integer.

In a further aspect, the present invention relates to a method of driving an LCD. In one embodiment, the method includes the step of providing an LCD comprising (a) a plurality of pixels, {P_{n,m}}, spatially arranged in the form of a matrix, n=1, 2, . . . , N, and m=1, 2, . . . , M, and N, M being an integer greater than zero, each pixel P_{n,m} comprising a first sub-pixel electrode, a second sub-pixel electrode, a first switching element electrically coupled to the first sub-pixel electrode, a second switching element electrically coupled to the second sub-pixel electrode, and a third switching element electrically coupled to the first and second switching elements, (b) a plurality of gate lines, {Gₙ}, spatially arranged along a row direction, wherein each pair of two neighboring gate lines Gₙ and Gₙ₊₁ defines a pixel row P_{n,{m}} of the pixel matrix {P_{n,m}} therebetween and is electrically coupled to the first and second switching elements of each pixel in the pixel row P_{n,{m}}, respectively, and (c) a plurality of data lines, {Dₘ}, spatially arranged crossing the plurality of gate lines {Gₙ} along a column direction perpendicular to the row direction. Each pair of two neighboring data lines Dₘ and Dₘ₊₁ defines a pixel column, P_{{n},m}, of the pixel matrix {P_{n,m}} therebetween, and is electrically coupled to the third switching element of each pixel P_{n,m} in the pixel column, P_{{n},m}.

In one embodiment, each of the first, second and third switching elements of the pixel P_{n,m} of the pixel matrix {P_{n,m}} is a field-effect thin film transistor having a gate, a source and a drain. The gate, the source and the drain of the first switching element of the pixel P_{n,m} are electrically coupled to the gate line Gₙ₊₁, the source of the second switching element of the pixel P_{n,m}, and the first sub-pixel electrode of the pixel P_{n,m}, respectively. The gate, the source and the drain of the second switching element of the pixel P_{n,m} are electrically coupled to the gate line Gₙ, the source of the first switching element of the pixel P_{n,m}, and the second sub-pixel electrode of the pixel P_{n,m}, respectively. The gate, the source and the drain of the third switching element of the pixel P_{n,m} are electrically coupled to the gate line Gₙ₊₂, the data line Dₘ, and the sources of the first and second switching elements of the pixel P_{n,m}, respectively. The gate, the source and the drain of the third switching element of the pixel P_{n+1,m} are electrically coupled to the gate line Gₙ₊₃, the data line Dₘ₊₁, and the sources of the first and second switching elements of the pixel P_{n+1,m}, respectively.

The method also includes the step of applying a plurality of gate signals to the plurality of gate lines {Gₙ} and a plurality of data signals to the plurality of data lines {Dₘ}, respectively, wherein the plurality of gate signals is configured to turn on the switching elements connected to the plurality of gate lines {Gₙ} in a predefined sequence, and the plurality of data signals is configured such that any two neighboring data signals have inverted polarities.

In one embodiment, each of the plurality of gate signals is configured to have a waveform. The waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, where the (j+1)-th duration Γⱼ₊₁ is immediately after the j-th duration Γⱼ, j=1, 2, 3 and 4, V₁=V₃=V₅>V₂=V₄, Γ₂=Γ₁/2, Γ₃=(Γ₁−t)/2, Γ₄=t, Γ₅=Γ₃, and Γ₁>>t. The waveform of each of the gate signals is sequentially shifted from one another by the duration of Γ₁.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, wherein:

FIG. 1 shows schematically a partial layout view of an LCD according to one embodiment of the present invention;

FIG. 2 shows time charts of driving signals applied to the LCD shown in FIG. 1;

FIG. 3 shows schematically pixel charging and holding processes (a)-(d) of the LCD shown in FIG. 1;

FIG. 4 shows simulation results of the pixel voltage potentials of the LCD for the gate signals shown in FIG. 1;

FIG. 5 shows schematically an LCD according to another embodiment of the present invention, (a) an equivalent circuit diagram, and (b) time charts of driving signals;

FIG. 6 shows schematically pixel charging and holding processes (a) and (b) of the LCD shown in FIG. 5; and

FIG. 7 shows time charts of driving signals (a) and pixel charging and holding processes (b)-(f) of a conventional LCD.

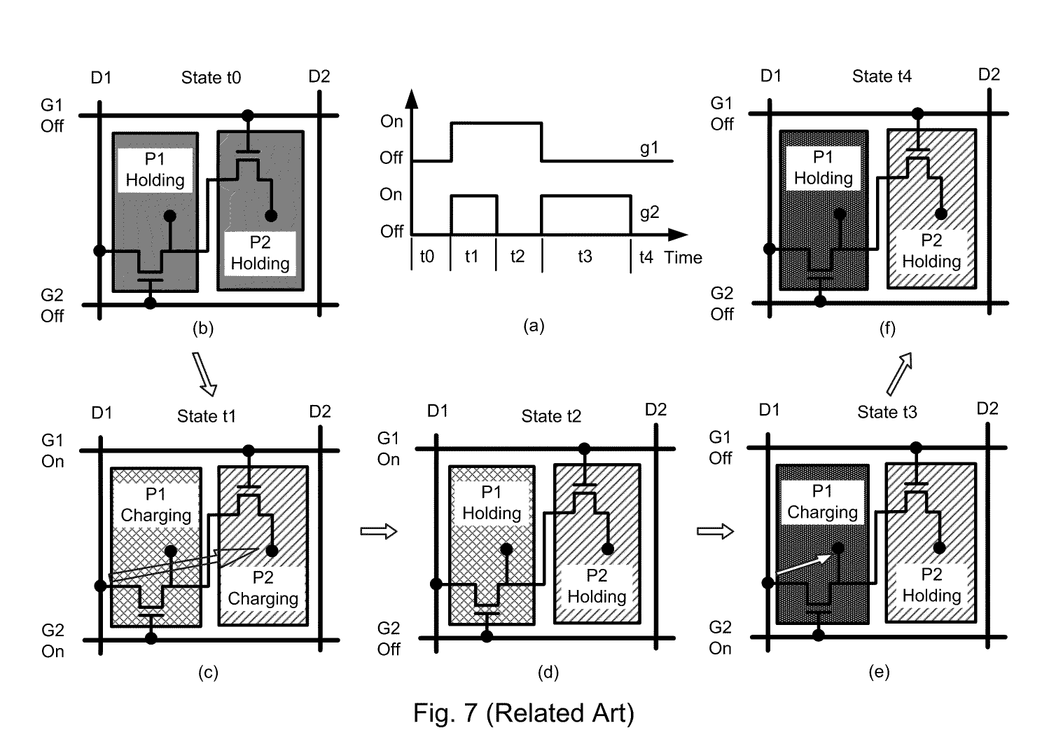

### DETAILED DESCRIPTION OF THE INVENTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

The term “HSD2”, as used herein, refers to a pixel arrangement and driving scheme of an LCD in which each pixel defined two neighboring gate lines is configured to have first and second switches electrically coupled to the two neighboring gate lines, respectively. The term “HSD3”, as used herein, refers to a pixel arrangement and driving scheme of an LCD in which each pixel defined two neighboring gate lines is configured to have first, second and third switches. The first and second switches are electrically coupled to the two neighboring gate lines, respectively, while the third switch is electrically coupled to the first and second switches and a third gate line that is immediately next to the two neighboring gate lines.

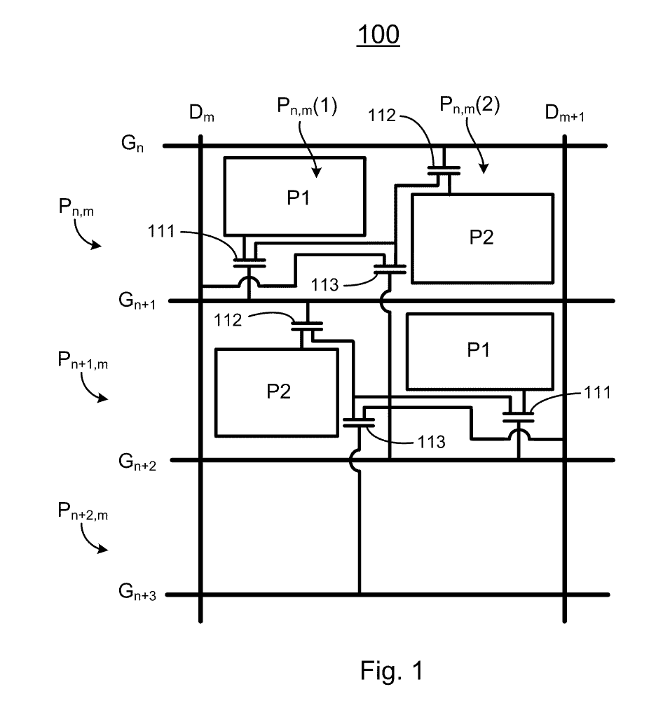

The description will be made as to the embodiments of the present invention in conjunction with the accompanying drawings in FIGS. 1-6. In accordance with the purposes of this invention, as embodied and broadly described herein, this invention, in one aspect, relates to an LCD that utilizes an HSD3 driving scheme to reduce power consumption and improve performance and methods of driving same.

Referring to FIG. 1, an LCD panel 100 according to one embodiment of the present invention is partially and schematically shown. The LCD panel 100 includes a plurality of gate lines, G₁, G₂, . . . , Gₙ, Gₙ₊₁, Gₙ₊₂, Gₙ₊₃, . . . , G_{N}, that are spatially arranged along a row (horizontal) direction, and a plurality of data lines, D₁, D₂, . . . , Dₘ, Dₘ₊₁, Dₘ₊₂, Dₘ₊₃, . . . , D_{M}, that are spatially arranged crossing the plurality of gate lines G₁, G₂, . . . , Gₙ, Gₙ₊₁, Gₙ₊₂, Gₙ₊₃, . . . , G_{N} along a column (vertical) direction that is perpendicular to the row direction. N and M are integers greater than one. The LCD panel 100 further has a plurality of pixels, {P_{n,m}}, that is spatially arranged in the form of a matrix. Each pixel P_{n,m} is defined between two neighboring gate lines Gₙ and Gₙ₊₁ and two neighboring data lines Dₘ and Dₘ₊₁. For the purpose of illustration of embodiments of the present invention, FIG. 1 schematically shows only four gate lines Gₙ, Gₙ₊₁, Gₙ₊₂ and Gₙ₊₃, two data lines Dₘ, and Dₘ₊₁, and three corresponding pixels of the LCD panel 100.

The pixel P_{n,m} located, for example, between two neighboring gate lines Gₙ and Gₙ₊₁ and two neighboring data lines Dₘ and Dₘ₊₁ crossing the two neighboring gate lines Gₙ and Gₙ₊₁, has a first sub-pixel electrode P1, a second sub-pixel electrode P2, a first transistor 111, a second transistor 112 and a third transistor 113.

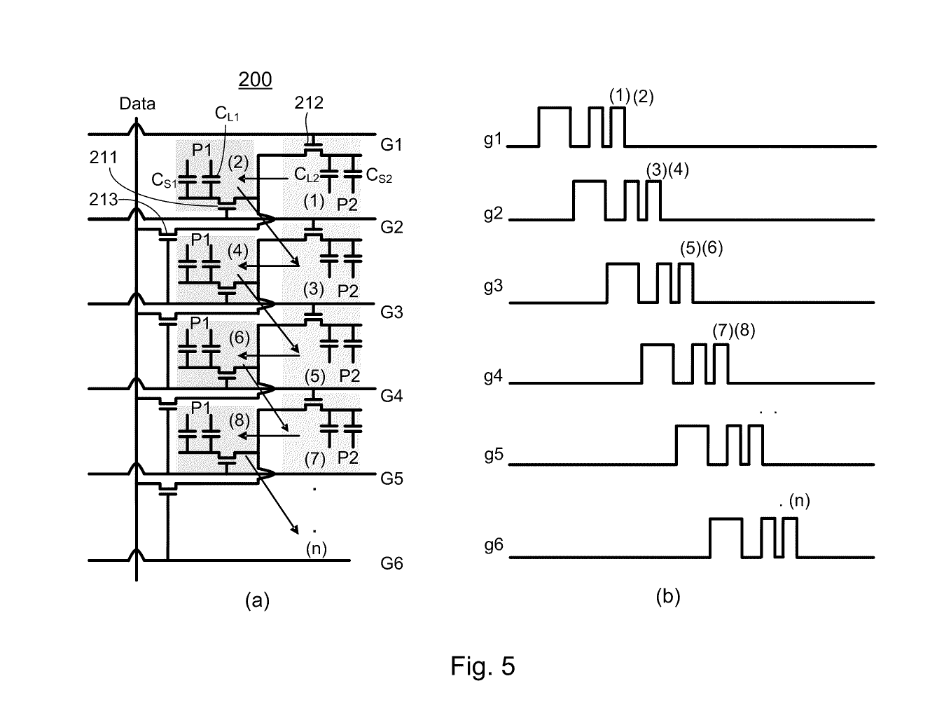

The first transistor 111 has a gate electrically coupled to the gate line Gₙ₊₁, a source and a drain electrically coupled to the first sub-pixel electrode P1. The second transistor 112 has a gate electrically coupled to the gate line Gₙ, a source electrically coupled to the source of the first transistor 111 and a drain electrically coupled to the second sub-pixel electrode P2. The third transistor 113 has a gate electrically coupled to the gate line Gₙ₊₂, a source electrically coupled to one of the two neighboring data lines Dₘ and Dₘ₊₁ and a drain electrically coupled to the sources of the first and second transistors 111 and 112. In the exemplary embodiment shown in FIG. 1, the source of the third transistor 113 of the pixel P_{n,m} is electrically coupled to the data line Dₘ when n is an odd positive integer, or electrically coupled to the data line Dₘ₊₁ when n is an even positive integer. In another embodiment as shown in FIG. 5 below, the source of the third transistor 113 of the pixel P_{n,m} is electrically coupled to the data line Dₘ.

Additionally, the LCD 100 also includes at least one common electrode (not shown) formed in relation to the first and second sub-pixel electrodes P1 and P2 of each pixel P_{n,m}. As shown in FIG. 5 below, each pixel P_{n,m} may further include a first LC capacitor, C_{L1}, a second LC capacitor, C_{L2}, a first storage capacitor, C_{S1}, and a second storage capacitor, C_{S2}. The first LC capacitor C_{L1} and the first storage capacitor C_{S1} are electrically coupled between the first sub-pixel electrode P1 and the at least one common electrode in parallel. The second LC capacitor C_{L2} and the second storage capacitor C_{S2} are electrically coupled between the second sub-pixel electrode P2 and the at least one common electrode in parallel.

Alternatively, each pixel P_{n,m} is configured to have two or more sub-pixels. The first sub-pixel electrode P1, the first transistor 111, the first LC capacitor C_{L1} and the first storage capacitor C_{S1} of each pixel P_{n,m} define a first sub-pixel, P_{n,m}(1), of the pixel P_{n,m}, while the second sub-pixel electrode P2, the second transistor 112, the second LC capacitor C_{L2} and the second storage capacitor C_{S2} of each pixel P_{n,m} define a second sub-pixel, P_{n,m}(2), of the pixel P_{n,m}. The first, second and third transistors 111, 112 and 113 in one embodiment are field-effect TFTs and adapted for activating the first sub-pixel P_{n,m}(1) and the second sub-pixel P_{n,m}(2), respectively. Other types of transistors may also be utilized to practice the present invention.

In one embodiment, the sub-pixel electrodes P1/P2 of the first sub-pixel P_{n,m}(1) and the second sub-pixel P_{n,m}(2) of each pixel P_{n,m} are deposited on a first substrate (not shown), while the common electrode is deposited on a second substrate (not shown) that is spatially apart from the first substrate. The LC molecules are filled into cells between the first and second substrates. Each cell is associated with a pixel P_{n,m} of the LCD 100. Voltages (potentials) applied to the sub-pixel electrodes P1 and P2 control orientation alignments of the LC molecules in the LC cells associated with the corresponding sub-pixels.

The LCD 100 further has a gate driver and a data driver (not shown). The gate driver is adapted for generating a plurality of gate signals, {gₙ}, respectively applied to the plurality of gate lines {Gₙ}. The plurality of gate signals {gₙ} is configured to turn on the first, second and third transistors 111, 112 and 113 connected to the plurality of gate lines {Gₙ} in a predefined sequence. The data driver is adapted for generating a plurality of data signals, {dₘ}, respectively applied to the plurality of data lines {Dₘ}.

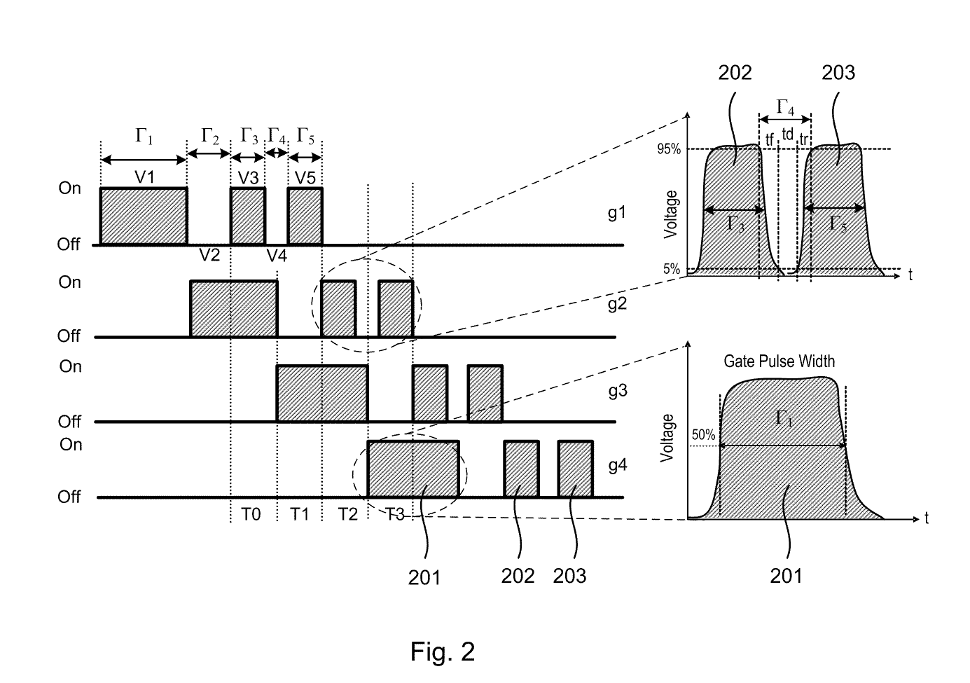

Referring to FIG. 2, waveform/time charts of the gate signals g₁, g₂, g₃ and g₄ applied to the LCD shown in FIG. 1 and charging in the corresponding sub-pixel electrodes P1 and P2 of the LCD are shown according to one embodiment of the present invention. Each of the gate signals g₁, g₂, g₃ and g₄ is configured to have a waveform. The waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, where the (j+1)-th duration Γⱼ₊₁ is immediately after the j-th duration Γⱼ, j=1, 2, 3 and 4, V₁=V₃=V₅>V₂=V₄, Γ₂=Γ₁/2, Γ₃=(Γ₁−t)/2, Γ₄=t, Γ₅=Γ₃, and Γ₁>>t≧Γ₁/40. In this embodiment, V₁ (V₃, V₅) and V₂ (V₄) are corresponding to a high voltage potential and a low voltage potential, respectively, for effectively turning on and off the corresponding transistors of a corresponding pixel row. The waveform of each of the gate signals g₁, g₂, g₃ and g₄ is sequentially shifted from one another so as to activate the three pixel rows in a predetermined order (sequence). In this exemplary embodiment, the gate signal g₂ is shifted by the duration of Γ₁ from the gate signal g₁; the gate signal g₃ is shifted by the duration of Γ₁ from the gate signal g₂; and the gate signal g₄ is shifted by the duration of Γ₁ from the gate signal g₃, respectively. Usually, the waveform of each gate signal is characterized with a plurality of pulses, for example, pulses 201, 202 and 203. Each pulse has a pulse width and height. Specifically, the pulse width and height of the pulse 201 define the first duration Γ₁ and the first voltage potential V₁, respectively; the pulse width and height of the pulse 202 define the third duration Γ₃ and the third voltage potential V₃, respectively; and the pulse width and height of the pulse 203 define the fifth duration Γ₅ and the fifth voltage potential V₅, respectively. The separation between the pulses 201 and 202 defines the second duration Γ₂, while the separation between the pulses 202 and 203 defines the fourth duration Γ₄. In one embodiment, Γ₁>>Γ₄(=t)>Γ₁/40.

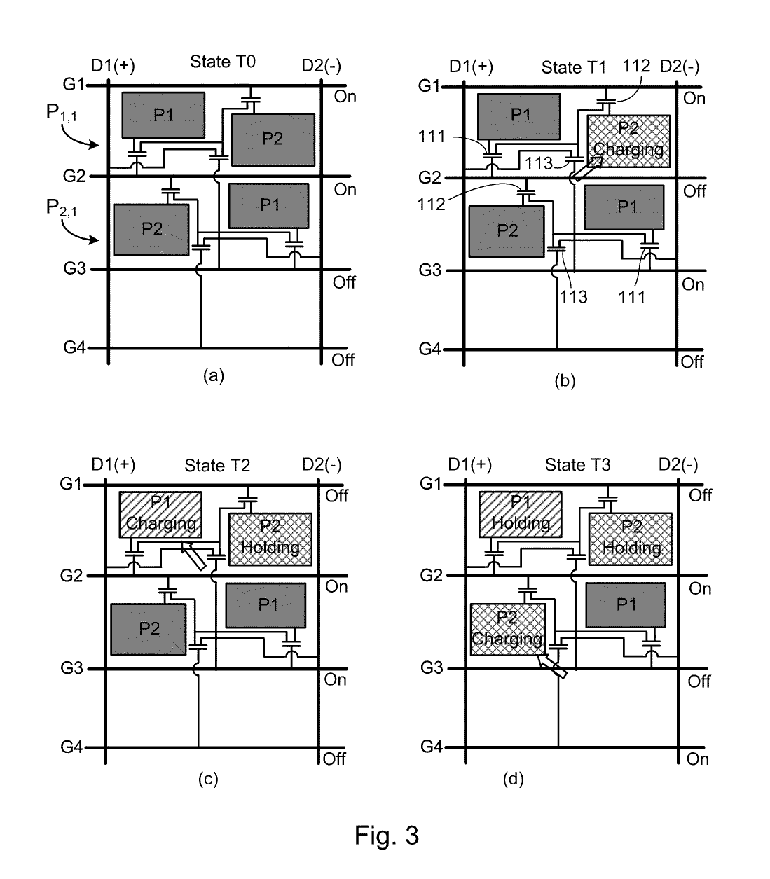

As shown in FIG. 3, when such gate signals g₁, g₂, g₃ and g₄ are applied to the gate lines G₁, G₂, G₃, and G₄, respectively, of the LCD shown in FIG. 1, the second feed-through effect on the first sub-pixel or the second sub-pixel will be avoided in operation.

For example, in the time period of T0, the gates G₁ and G₂ are turned on, while the gates G₃ and G₄ are turned off. Accordingly, the third transistors 113 of both the pixels P_{1,1} and P_{2,1} are turned off. Thus, no data signals are applied to the first and second sub-pixels of the pixels P_{1,1} and P_{2,1} through the data line D₁ or D₂. This is corresponding to State T0, as shown in FIG. 3(a).

In the time period of T1, the gates G₁ and G₃ are turned on, while the gates G₂ and G₄ are turned off. Accordingly, the second transistor 112 and the third transistor 113 of the pixel P_{1,1} are turned on, whereby the data signal is applied to the second sub-pixel of the pixel P_{1,1} through the data line D₁, and the second sub-pixel electrode P2 of the pixel P_{1,1} is charged. This is corresponding to State T1, as shown in FIG. 3(b).

In the time period of T2, the gates G₂ and G₃ are turned on, while the gates G₁ and G₄ are turned off. Accordingly, the first transistor 111 and the third transistor 113 of the pixel P_{1,1} are turned on, whereby the data signal is applied to the first sub-pixel of the pixel P_{1,1} through the data line D₁, and the first sub-pixel electrode P1 of the pixel P_{1,1} is charged and the second sub-pixel electrode P2 of the pixel P_{1,1} is held. This is corresponding to State T2, as shown in FIG. 3(c).

In the time period of T3, the gates G₂ and G₄ are turned on, while the gates G₁ and G₃ are turned off. Accordingly, the second transistor 112 and the third transistor 113 of the pixel P_{2,1} are turned on, whereby the data signal is applied to the second sub-pixel of the pixel P_{2,1} through the data line D₂, and the second sub-pixel electrode P2 of the pixel P_{2,1} is charged, and the first and second sub-pixel electrodes P1 and P2 of the pixel P_{1,1} are held. This is corresponding to State T3, as shown in FIG. 3(d).

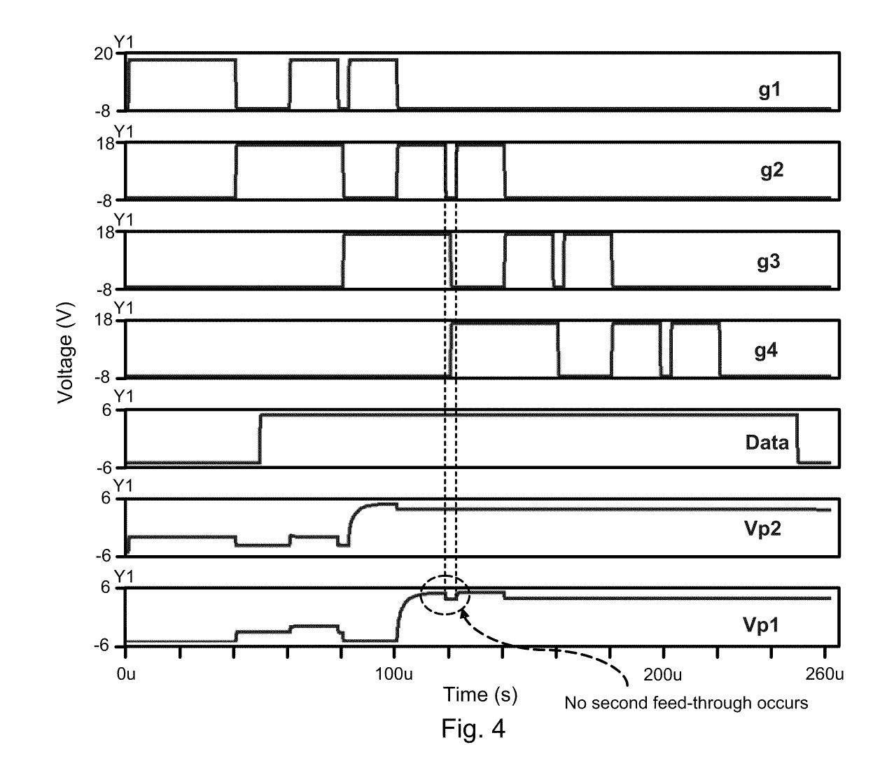

FIG. 4 and Table 1 show simulation results for the gate signals g₁, g₂, g₃ and g₄ having a waveform same as that shown in FIG. 2. The final voltages charged in the sub-pixels P1 and P2 are almost identical. Thus, The HSD3 driving scheme according to the present invention has more uniform charging and better holding performance comparing to the HSD2 driving scheme.

TABLE 1
Simulation Results of the LCD at Frame Rate = 50 Hz.

| | | Charging Check | | | After | | | |
|---|---|---|---|---|---|---|---|---|
| | | | | Vₚ | Feed- | Holding Check | | |
| Driving | Sub- | | | (Charging | Through | (Leakage Current) | | |
| Method | Pixel | T_{ch} | W/L | Ratio) | Vₚ′ | T_{hold} | V_{hold} | ΔV |
| HSD2 | P1 | 33us | 210 um/ | 14.76 V | 12.78 V | 19.96 ms | 11.77 V | −1.02 V |
| | | | 5 um | (99.2%) | | | | |
| | P2 | | | 11.19 V | 9.05 V | | 9.31 V | +0.26 V |
| | | | | (87.3%) | | | | |
| HSD3 | P1 | 33us | 210 um/ | 12.44 V | 10.11 V | 19.96 ms | 9.804 V | −0.185 V |
| | | | 5 um | (91.5%) | | | | |
| | P2 | | | 12.44 V | 10.15 V | | 9.848 V | −0.181 V |
| | | | | (91.5%) | | | | |

(Tch is the pixel charging time; W/L represents the sub-pixel width and length; Vₚ and Vₚ′ are the sub-pixel voltages; Thold is the holding time; Vhold is the holding voltages; and ΔV represents the voltage difference between Vₚ′ and Vhold.)

FIG. 5(a) shows partially and schematically an LCD 200 according to another embodiment of the present invention. The configuration of the LCD 200 is same as that of the LCD 100 shown in FIG. 1, except that the source of the third transistor 213 of each pixel P_{n,m} is electrically coupled to the data line Dₘ. FIG. 5(b) shows time charts of the gate signals g₁, g₂, . . . , and g₆ sequentially applied to the gate line G1, G2, . . . , and G6, respectively, of the LCD. Each of the gate signals g₁, g₂, . . . , and g₆ has a waveform same as that shown in FIG. 2. Accordingly, the pixel charging sequence is from sub-pixel (1) to sub-pixel (2) to sub-pixel (3), . . . , to sub-pixel (n).

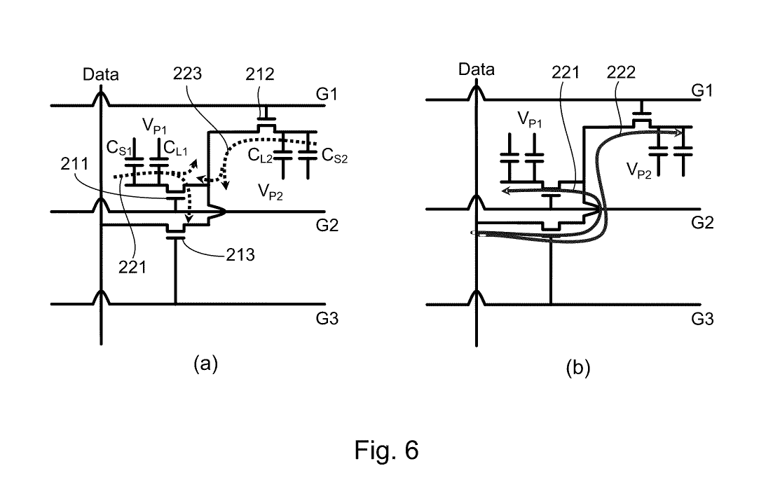

FIG. 6(a) shows pixel discharging processes of the LCD 200, indicated by the current leakage path 223, while FIG. 6(b) pixel charging processes of the LCD 200, indicated by the charging path 221 for the sub-pixel P1 and the charging path 222 for the sub-pixel P2.

According to the embodiments of the present invention as disclosed above, a half source channel amount is reduced and the aperture ratio is improved in the LCD with the HSD3 driving scheme, comparing to a conventional LCD. Further, the LCD of the present invention has good uniformity in charging and holding performance.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A liquid crystal display (LCD), comprising:
(a) a plurality of gate lines, {Gₙ}, n=1, 2, . . . , N, N being an integer greater than zero, spatially arranged along a row direction;
(b) a plurality of data lines, {Dₘ}, m=1, 2, . . . , M, M being an integer greater than zero, spatially arranged crossing the plurality of gate lines {Gₙ} along a column direction perpendicular to the row direction; and
(c) a plurality of pixels, {P_{n,m}}, spatially arranged in the form of a matrix, each pixel P_{n,m} defined between two neighboring gate lines Gₙ and Gₙ₊₁ and two neighboring data lines Dₘ and Dₘ₊₁, and comprising:
(i) a first sub-pixel electrode;
(ii) a second sub-pixel electrode;
(iii) a first transistor having a gate electrically coupled to the gate line Gₙ₊₁, a source, and a drain electrically coupled to the first sub-pixel electrode;
(iv) a second transistor having a gate electrically coupled to the gate line Gₙ, a source electrically coupled to the source of the first transistor, and a drain electrically coupled to the second sub-pixel electrode; and
(v) a third transistor having a gate electrically coupled to the gate line Gₙ₊₂, a source electrically coupled to one of the two neighboring data lines Dₘ and Dₘ₊₁, and a drain electrically coupled to the sources of the first and second transistors.

2. The LCD of claim 1, wherein the source of the third transistor of the pixel P_{n,m} is electrically coupled to the data line Dₘ.

3. The LCD of claim 1, wherein the source of the third transistor of the pixel P_{n,m} is electrically coupled to the data line Dₘ when n is an odd positive integer, or electrically coupled to the data line Dₘ₊₁ when n is an even positive integer.

4. The LCD of claim 1, further comprising at least one common electrode formed in relation to the first and second sub-pixel electrodes of each pixel P_{n,m}.

5. The LCD of claim 4, wherein each pixel P_{n,m} further comprises a first liquid crystal (LC) capacitor, a second LC capacitor, a first storage capacitor and a second storage capacitor, wherein the first LC capacitor and the first storage capacitor are electrically coupled between the first sub-pixel electrode and the at least one common electrode in parallel, and wherein the second LC capacitor and the second storage capacitor are electrically coupled between the second sub-pixel electrode and the at least one common electrode in parallel.

6. The LCD of claim 5, wherein the first sub-pixel electrode, the first transistor, the first LC capacitor, and the first storage capacitor of each pixel P_{n,m} define a first sub-pixel, P_{n,m}(1), of the pixel P_{n,m}, while the second sub-pixel electrode, the second transistor, the second LC capacitor, and the second storage capacitor of each pixel P_{n,m} define a second sub-pixel, P_{n,m}(2), of the pixel P_{n,m}.

7. The LCD of claim 1, further comprising:
(a) a gate driver for generating a plurality of gate signals respectively applied to the plurality of gate lines {Gₙ}, wherein the plurality of gate signals is configured to turn on the transistors connected to the plurality of gate lines {Gₙ} in a predefined sequence; and
(b) a data driver for generating a plurality of data signals respectively applied to the plurality of data lines {Dₘ}, wherein the plurality of data signals is configured such that any two neighboring data signals have inverted polarities.

8. The LCD of claim 7, wherein each of the plurality of gate signals is configured to have a waveform, wherein the waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, wherein the (j+1)-th duration Γⱼ₊₁ is immediately after the j-th duration Γⱼ, j=1, 2, 3 and 4, and wherein V₁=V₃=V₅>V₂=V₄, Γ₂=Γ₁/2, Γ₃=(Γ₁−t)/2, Γ₄=t, Γ₅=Γ₃, and Γ₁>>t.

9. The LCD of claim 8, wherein the waveform of each of the gate signals is sequentially shifted from one another by the duration of Γ₁.

10. A method of driving a liquid crystal display (LCD), comprising the steps of:
(a) providing an LCD panel comprising:
(i) a plurality of gate lines, {Gₙ}, n=1, 2, . . . , N, N being an integer greater than zero, spatially arranged along a row direction;
(ii) a plurality of data lines, {Dₘ}, m=1, 2, . . . , M, M being an integer greater than zero, spatially arranged crossing the plurality of gate lines {Gₙ} along a column direction perpendicular to the row direction; and
(iii) a plurality of pixels, {P_{n,m}}, spatially arranged in the form of a matrix, each pixel defined between two neighboring gate lines Gₙ and Gₙ₊₁ and two neighboring data lines Dₘ and Dₘ₊₁, and comprising:
a first sub-pixel electrode;
a second sub-pixel electrode;
a first transistor having a gate electrically coupled to the gate line Gₙ₊₁, a source, and a drain electrically coupled to the first sub-pixel electrode;
a second transistor having a gate electrically coupled to the gate line Gₙ, a source electrically coupled to the source of the first transistor and a drain electrically coupled to the second sub-pixel electrode; and
a third transistor having a gate electrically coupled to the gate line Gₙ₊₂, a source electrically coupled to one of the two neighboring data lines Dₘ and Dₘ₊₁ and a drain electrically coupled to the sources of the first and second transistors; and
(b) applying a plurality of gate signals to the plurality of gate lines {Gₙ} and a plurality of data signals to the plurality of data lines {Dₘ}, respectively, wherein the plurality of gate signals is configured to turn on the transistors connected to the plurality of gate lines {Gₙ} in a predefined sequence, and the plurality of data signals is configured such that any two neighboring data signals have inverted polarities.

11. The method of claim 10, wherein each of the plurality of gate signals is configured to have a waveform, wherein the waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, wherein the (j+1)-th duration Γⱼ₊₁ is immediately after the j-th duration Γⱼ, j=1, 2, 3 and 4, and wherein V₁=V₃=V₅>V₂=V₄, Γ₂=Γ₁/2, Γ₃=(Γ₁−t)/2, Γ₄=t, Γ₅=Γ₃, and Γ₁>>t.

12. The method of claim 11, wherein the waveform of each of the gate signals is sequentially shifted from one another by the duration of Γ₁.

13. A liquid crystal display (LCD), comprising:
(a) a plurality of pixels, {P_{n,m}}, spatially arranged in the form of a matrix, n=1, 2, . . . , N, and m=1, 2, . . . , M, and N, M being an integer greater than zero, each pixel P_{n,m} comprising a first sub-pixel electrode, a second sub-pixel electrode, a first switching element electrically coupled to the first sub-pixel electrode, a second switching element electrically coupled to the second sub-pixel electrode, and a third switching element electrically coupled to the first and second switching elements;
(b) a plurality of gate lines, {Gₙ}, spatially arranged along a row direction, wherein each pair of two neighboring gate lines Gₙ and Gₙ₊₁ defines a pixel row P_{n,{m}} of the pixel matrix {P_{n,m}} therebetween and is electrically coupled to the first and second switching elements of each pixel P_{n,{m}} in the pixel row P_{n,{m}}, respectively; and
(c) a plurality of data lines, {Dₘ}, spatially arranged crossing the plurality of gate lines {Gₙ} along a column direction perpendicular to the row direction, wherein each pair of two neighboring data lines Dₘ and Dₘ₊₁ defines a pixel column, P_{{n},m}, of the pixel matrix {P_{n,m}} therebetween, and is electrically coupled to the third switching element of each pixel P_{n,m} in the pixel column, P_{{n},m}.

14. The LCD of claim 13, wherein the first sub-pixel electrode and the first switching element of the pixel P_{n,m} define a first sub-pixel, P_{n,m}(1), of the pixel P_{n,m}, while the second sub-pixel electrode and the second switching element of the pixel P_{n,m} define a second sub-pixel, P_{n,m}(2), of the pixel P_{n,m}.

15. The LCD of claim 13, wherein each of the first, second and third switching elements of the pixel P_{n,m} of the pixel matrix {P_{n,m}} is a field-effect thin film transistor having a gate, a source and a drain.

16. The LCD of claim 15, wherein the gate, the source and the drain of the first switching element of the pixel P_{n,m} are electrically coupled to the gate line Gₙ₊₁, the source of the second switching element of the pixel P_{n,m}, and the first sub-pixel electrode of the pixel P_{n,m}, respectively; and
wherein the gate, the source and the drain of the second switching element of the pixel P_{n,m} are electrically coupled to the gate line Gₙ, the source of the first switching element of the pixel P_{n,m}, and the second sub-pixel electrode of the pixel P_{n,m}, respectively.

17. The LCD of claim 16, wherein the gate, the source and the drain of the third switching element of the pixel P_{n,m} are electrically coupled to the gate line Gₙ₊₂, the data line Dₘ, and the sources of the first and second switching elements of the pixel P_{n,m}, respectively.

18. The LCD of claim 16, wherein the gate and the drain of the third switching element of the pixel P_{n,m} are electrically coupled to the gate line Gₙ₊₂ and the sources of the first and second switching elements of the pixel P_{n,m}, respectively, while the source of the third transistor of the pixel P_{n,m} is electrically coupled to the data line Dₘ when n is an odd positive integer, or electrically coupled to the data line Dₘ₊₁ when n is an even positive integer.

19. The LCD of claim 13, further comprising:
(a) a gate driver for generating a plurality of gate signals respectively applied to the plurality of gate lines {Gₙ}, wherein the plurality of gate signals is configured to turn on the switching elements connected to the plurality of gate lines {Gₙ} in a predefined sequence; and
(b) a data driver for generating a plurality of data signals respectively applied to the plurality of data lines {Dₘ}, wherein the plurality of data signals is configured such that any two neighboring data signals have inverted polarities.

20. A method of driving a liquid crystal display (LCD), comprising the steps of:
(a) providing an LCD panel comprising:
(i) a plurality of pixels, {P_{n,m}}, spatially arranged in the form of a matrix, n=1, 2, . . . , N, and m=1, 2, . . . , M, and N, M being an integer greater than zero, each pixel P_{n,m} comprising a first sub-pixel electrode, a second sub-pixel electrode, a first switching element electrically coupled to the first sub-pixel electrode, a second switching element electrically coupled to the second sub-pixel electrode, and a third switching element electrically coupled to the first and second switching elements;
(ii) a plurality of gate lines, {Gₙ}, spatially arranged along a row direction, wherein each pair of two neighboring gate lines Gₙ and Gₙ₊₁ defines a pixel row P_{n,{m}} of the pixel matrix {P_{n,m}} therebetween and is electrically coupled to the first and second switching elements of each pixel P_{n,m} in the pixel row P_{n,{m}}, respectively; and
(iii) a plurality of data lines, {Dₘ}, spatially arranged crossing the plurality of gate lines {Gₙ} along a column direction perpendicular to the row direction, wherein each pair of two neighboring data lines Dₘ and Dₘ₊₁ defines a pixel column, P_{{n},m}, of the pixel matrix {P_{n,m}} therebetween, and is electrically coupled to the third switching element of each pixel P_{n,m} in the pixel column, P_{{n},m}; and
(b) applying a plurality of gate signals to the plurality of gate lines {Gₙ} and a plurality of data signals to the plurality of data lines {Dₘ}, respectively, wherein the plurality of gate signals is configured to turn on the switching elements connected to the plurality of gate lines {Gₙ} in a predefined sequence, and the plurality of data signals is configured such that any two neighboring data signals have inverted polarities.

21. The method of claim 20, wherein each of the first, second and third switching elements of the pixel P_{n,m} of the pixel matrix {P_{n,m}} is a field-effect thin film transistor having a gate, a source and a drain.

22. The method of claim 21, wherein the gate, the source and the drain of the first switching element of the pixel P_{n,m} are electrically coupled to the gate line Gₙ₊₁, the source of the second switching element of the pixel P_{n,m}, and the first sub-pixel electrode of the pixel P_{n,m}, respectively; and
wherein the gate, the source and the drain of the second switching element of the pixel P_{n,m} are electrically coupled to the gate line Gₙ, the source of the first switching element of the pixel P_{n,m}, and the second sub-pixel electrode of the pixel P_{n,m}, respectively.

23. The method of claim 22, wherein the gate, the source and the drain of the third switching element of the pixel P_{n,m} are electrically coupled to the gate line Gₙ₊₂, the data line Dₘ, and the sources of the first and second switching elements of the pixel P_{n,m}, respectively.

24. The method of claim 22, wherein the gate and the drain of the third switching element of the pixel P_{n,m} are electrically coupled to the gate line Gₙ₊₂ and the sources of the first and second switching elements of the pixel P_{n,m}, respectively, while the source of the third transistor of the pixel P_{n,m} is electrically coupled to the data line Dₘ when n is an odd positive integer, or electrically coupled to the data line Dₘ₊₁ when n is an even positive integer.

25. The method of claim 20, wherein each of the plurality of gate signals is configured to have a waveform, wherein the waveform has a first voltage potential V₁ in a first duration, Γ₁, a second voltage potential V₂ in a second duration, Γ₂, a third voltage potential V₃ in a third duration, Γ₃, a fourth voltage potential V₄ in a fourth duration, Γ₄, and a fifth voltage potential V₅ in a fifth duration, Γ₅, wherein the (j+1)-th duration Γⱼ₊₁ is immediately after the j-th duration Γⱼ, j=1, 2, 3 and 4, and wherein V₁=V₃=V₅>V₂=V₄, Γ₂=Γ₁/2, Γ₃=(Γ₁−t)/2, Γ₄=t, Γ₅=Γ₃, and Γ₁>>t.

26. The method of claim 25, wherein the waveform of each of the gate signals is sequentially shifted from one another by the duration of Γ₁.
